(19) United States
(12) Patent Application Publication
(10) Pub. No.: US 2013/0185711 A1
(43) Pub. Date: Jul. 18, 2013

(54) MOBILE PHONE MOVIE QUOTE APPLICATION

(71) Applicant: Daniel Morales, San Antonio, TX (US)

(72) Inventor: Daniel Morales, San Antonio, TX (US)

(21) Appl. No.: 13/350,081

(22) Filed: Jan. 13, 2012

(51) Int. Cl. G06F 9/44

(52) U.S. Cl. 717/173

(57) ABSTRACT

The present invention is a system to access and utilize a mobile phone movie quote that includes a server system, a mobile phone that includes a main display screen, a tags screen, a type search screen, a speak type search screen, a friends type screen and a voice receiving device and a communications network where the server system is in communication with the mobile phone over the communications network downloads. The mobile phone movie quote application that resides on the server system includes a home page screen, a tag screen, a movie screen, an actor or actresses screen, a quote screen and a friends screen and a plurality of app updates that are provided to the mobile phone movie quote application to keep the system current.

### TECHNICAL FIELD & BACKGROUND

Many times in friendly conversation, movies, films and related quotes are referenced without the ability to recall the actor or the film from which the actors, the films or the quotes are derived. Currently there are limited alternatives to sources of information which help to quickly and accurately identify specific actors and/or lines from a movie or a film.

The present invention generally relates to a mobile phone application. More specifically, the invention is a mobile phone movie quote application.

It is an object of the invention to provide a mobile phone application that provides an individual with a mobile phone application capable of searching and providing one or more movie or film quotes.

It is an object of the invention to provide a mobile phone application that provides an individual with a mobile phone application capable of searching and providing one or more movie or film quotes that can be shared with one or more user friends.

It is an object of the invention to provide a mobile phone application integrated with one or more of the user's friend's social media accounts such as Facebook and Twitter or other suitable social media accounts.

What is really needed is a mobile phone application that provides an individual with a mobile phone application capable of searching and providing one or more movie or film quotes that can be shared with one or more user friends that is also integrated with one or more of the user's friend's social media accounts such as Facebook and Twitter or other suitable social media accounts.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of a mobile phone movie quote application, in accordance with one embodiment of the present invention.

FIG. 2 illustrates a block diagram of a server system of a mobile phone movie quote application, in accordance with one embodiment of the present invention.

FIG. 3 illustrates a block diagram of a mobile phone movie quote application, in accordance with one embodiment of the present invention.

FIG. 4 illustrates a front perspective view of a mobile phone with a mobile phone movie quote application, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

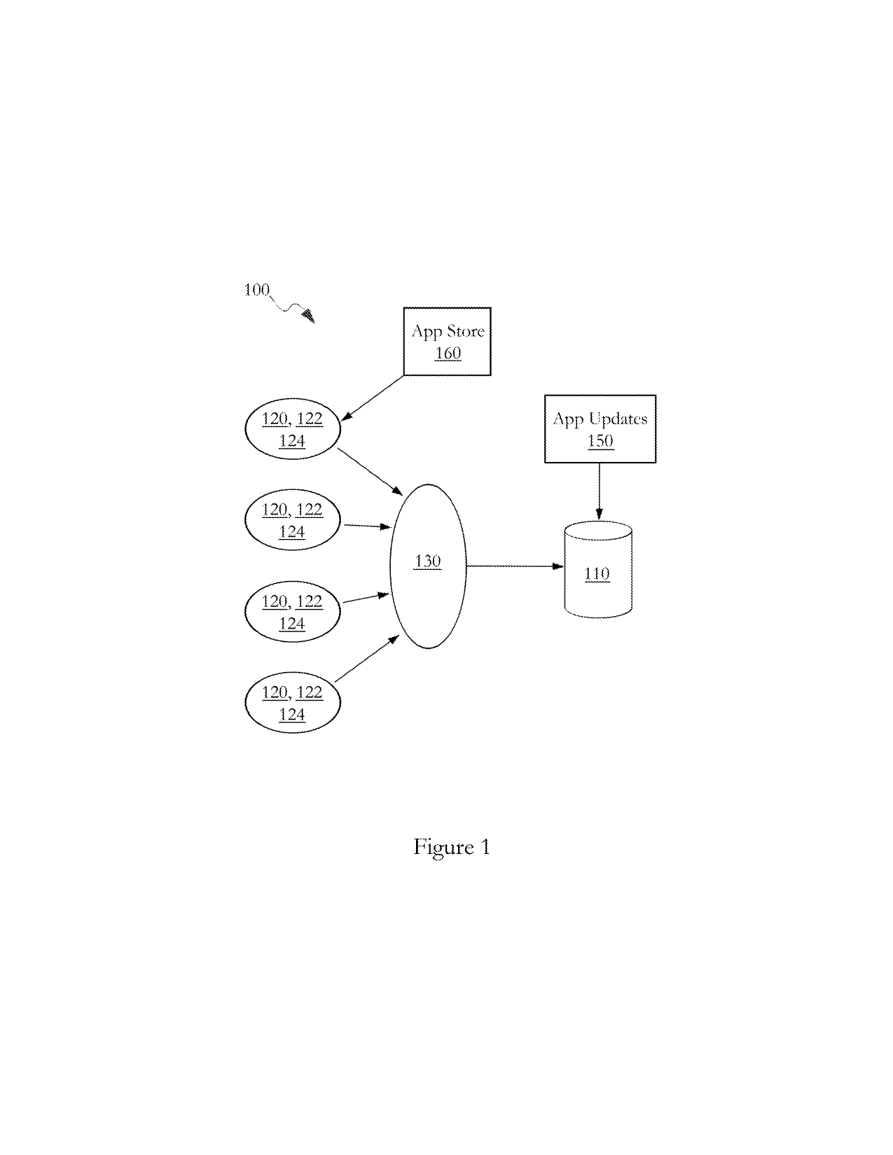

FIG. 1 illustrates a system 100 overview of a mobile phone movie quote application, in accordance with one embodiment of the present invention.

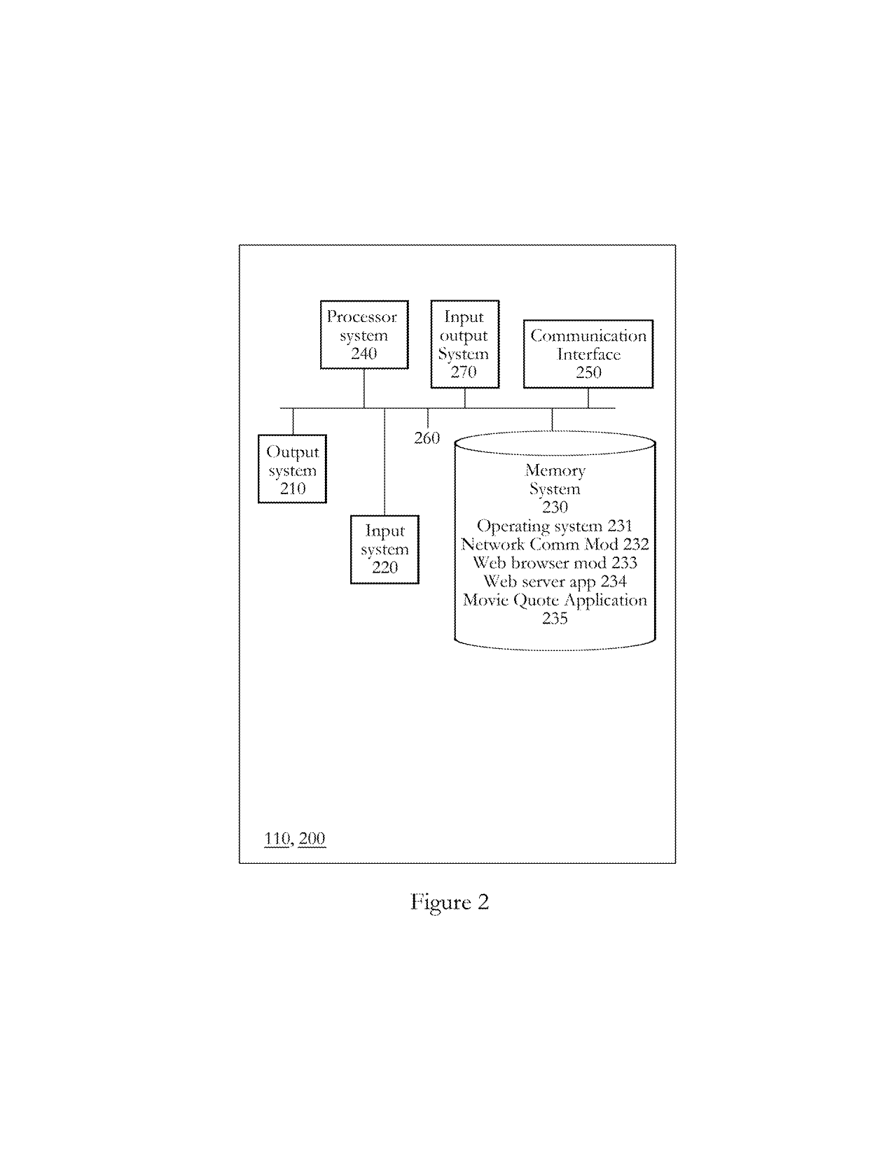

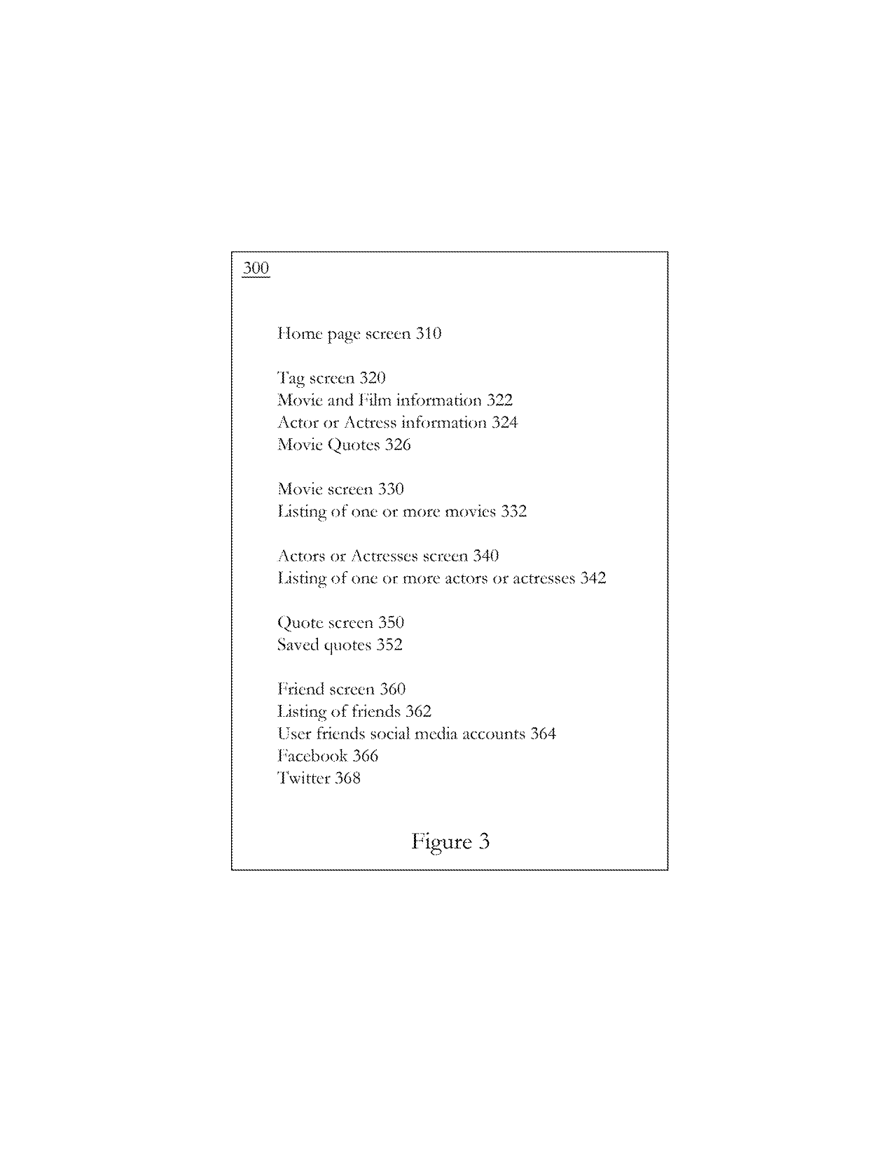

The system 100 includes a server system 110, one or more mobile phones 120, a communications network 130, a movie quote application 140, a plurality of app updates 150 and an app store 160. The server system 110 may have one or more servers and may include additional components and/or may not include all of the components listed above. Further details regarding the server system 110 are described in FIG. 2A. The mobile phones 120 are typically a smartphone 122 such as an IPHONE™ manufactured by Apple Inc. of Cupertino, Calif. as depicted in FIG. 3 although other suitable mobile phones and smartphones such as a BLACKBERRY™ device manufactured by Research in Motion (RIM) of Waterloo, Ontario, Canada can also be utilized with the system. These smartphones 120 serve as a client system 124 in the system 100. The smartphone 120 supports special software applications operating on various operating systems and can be JAVA enabled or other suitable programming language and computing platform or Binary Runtime Environment for Wireless (BREW) enabled or other suitable application development platform. The communications network 130 may be any one of, or any combination of, one or more Local Area Networks (LANs), Wide Area Networks (WANs), wireless networks, telephone networks, the Internet and/or other suitable networks. The communications network 130 may also include one or more wireless portals. The movie quote application 140 includes mobile phone software that is downloaded from the server system 110 to the mobile phone 120. Further details regarding the movie quote application 140 are provided in FIGS. 2A and 2B. The app updates 150 are provided to keep the movie quote application 140 and system 100 current. The app store 160 serves as a second source for providing the movie quote application 140 download to the system 100 in contrast to downloading the movie quote application 140 over the communications network 130 from the server system 110.

FIG. 2 illustrates block diagram of a server system 200 of a system of a mobile phone movie quote application, in accordance with one embodiment of the present invention.

The server system 200 may include an output system 210, an input system 220, a memory system 230, a processor system 240, a communications interface 250, a communications system 260 and an input/output system 270. The server system 200 may include additional components and/or may not include all of the components listed above. The server system 200 is the same server system 110 illustrated and described in FIG. 1 and its description.

The output system 210 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or Internet, for example.

The input system 220 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or Internet (e.g., IrDA, USB), for example.

The memory system 230 may include, for example, any one of, some of, any combination of, or all of a long term storage system, such as a hard drive, a short term storage system, such as random access memory, a removable storage system, such as a floppy drive or a removable drive and/or flash memory. Memory system 230 may include one or more machine-readable mediums that may store a variety of different types of information. The term machine-readable medium is used to refer to any medium capable carrying information that is readable by a machine. One example of a machine-readable medium is a computer-readable medium. Memory system 230 may store one or more machine instructions for producing web pages for and collecting information for operators or establishments and/or patrons regarding wait-times at different times of the day.

The memory system 230 may also include an operating system 231, a network communications module 232, a web browser module 233, a web server application 234 and a movie quote application app 235. The operating system 231 is provided on the memory system 230. The communications module 232 enables the server system 200 to communicate on the communications network 130 and is stored on the memory system 230. The web browser module 233 allows for browsing the Internet that is stored on the memory system 230. The web server application 234 is software provided to allow for browsing on the Internet. The movie quote application 235 is the same movie quote application 140 that is downloaded to the mobile phone 120 described and illustrated in previous FIG. 1 and is further subsequently described in FIG. 2B and its description.

The processor system 240 may include any one of, some of, any combination of, or all of multiple parallel processors, a single processor, a system of processors having one or more central processors and/or one or more specialized processors dedicated to specific tasks. Processor system 240 may include one or more digital signal processors (DSPs) in addition to or in place of one or more central processing units (CPUs) and/or may have one or more digital signal processing programs that run on one or more CPU. Processor system 240 may implement the machine instructions stored in memory system 230.

The communication interface 250 allows the server system 200 to interface with the communications network 130 described in previous FIG. 1. Communications system 260 communicatively links output system 210, input system 220, memory system 230, processor system 240 and/or input/output system 270 to each other. Communications system 260 may include any one of, some of, any combination of, or all of electrical cables, fiber optic cables, and/or sending signals through air or water (e.g. wireless communications), or the like. Some examples of sending signals through air and/or water include systems for transmitting electromagnetic waves such as infrared and/or radio waves and/or systems for sending sound waves.

The input/output system 270 may include devices that have the dual function as input and output devices. For example, input/output system 270 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 270 is optional and may be used in addition to or in place of output system 210 and/or input device 220.

FIG. 3 illustrates a block diagram of a movie quote application 300, in accordance with one embodiment of the present invention. The movie quote application is a similar movie quote application 235 described and illustrated in FIG. 2.

The movie quote application 300 includes a home page screen 310, a tag screen 320, a movie screen 330, an actors or actresses screen 340, a quote screen 350 and a friend's screen 360.

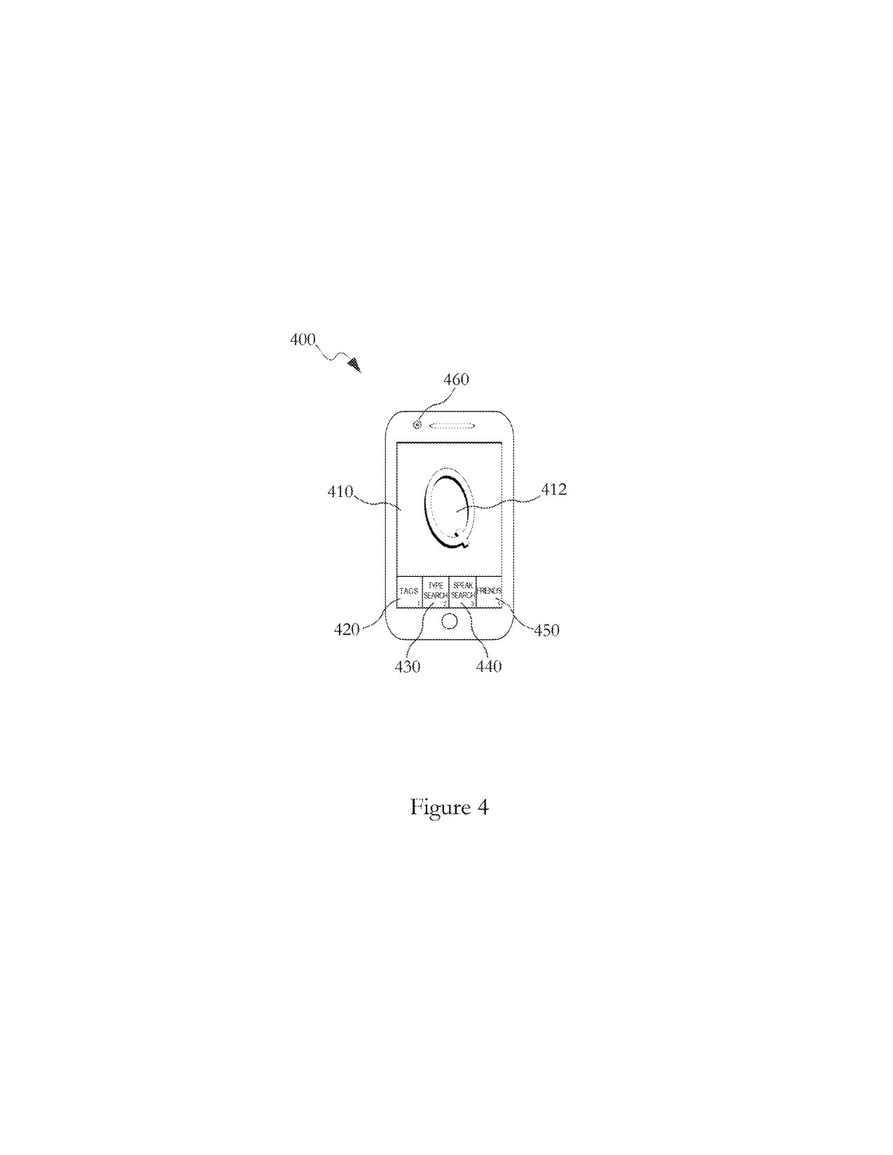

The home page screen 310 is the initial screen that is displayed when the movie quote application 300 is opened and is described and illustrated in greater detail in FIG. 4 and its description. The tag screen 320 includes a listing of information accessible to the movie quote application 300 that includes movie and film information 322, actor or actress information 324 and movie quotes 326. The movie screen 330 includes a listing of one or more movies 332 that have been accessed or utilized by the user that are available to access quotes from. The actors or actresses screen 340 includes a listing of one or more actors or actresses 342 that have been accessed or utilized by the user that are available to access quotes from. The quotes screen 350 saves all of the quotes 352 that are saved and are residing on the movie quote application 300. The friends screen 360 is a listing of all of the user's friends 362 that have mobile phones with the movie quote application 300 residing on them. The user's friends 362 and information from the movie quote application 300 can be in communication over the Internet or other suitable communications network to be integrated with one or more of the user's friend's social media accounts 364 such as Facebook 366 and Twitter 368 and other suitable social media accounts.

FIG. 4 illustrates a front perspective view of a mobile phone 400 with a mobile phone movie quote application 100, in accordance with one embodiment of the present invention. As previously indicated in FIG. 1, the mobile phone 400 can be any suitable mobile phone or smartphone such as an IPhone or Blackberry that can receive a downloaded movie quote application 140. The mobile phone 400 illustrated displays the home page screen 310 which is the initial screen that is displayed when the movie quote application 300 is opened.

The mobile phone 400 illustrated includes a main display screen 410, a tags screen 420, a type search screen 430, a speak type search screen 440, a friends type screen 450 and a voice receiving device 460.

The main display screen 410 displays the home page screen 310, the tag screen 320, the movie screen 330, the actors or actresses screen 340, the quote screen 350, the friends screen 360 and any other suitable screens from the mobile phone movie quote application 100. The main display screen 410 also displays a specifically engineered logo 412 when the main display screen 410 is not in use. The tags screen 420 contains the previously described tag screen 320 information that includes a listing of information accessible to the movie quote application 300 that includes movie and film information 322, actor or actress information 324 and one or more movie quotes 326. The type search screen 430 is integrated into a keyboard (not shown) that allows a user to type any search information into the keyboard disposed on the main display screen 410. The speak search screen 440 receives voice commands that allows a user to search any information related to the mobile phone movie quote application 100. The friends type screen 450 is integrated into the previously described friends screen 360 that is a listing of all of the user's friends 362 that have mobile phones with the movie quote application 300 residing on them. The voice receiving device 460 is integrated with the speak search screen 440 that receives voice commands that allows a user to search any information related to the mobile phone movie quote application 100.

The mobile phone movie quote application allows an individual to search for quotes via a typed written search or a verbal spoken search. Quick and efficient, the mobile phone movie quote application initially opens with a home page screen, afforded a specifically engineered logo or indicia, which allows access to various other screens such as a tag screen, a movie screen, a quote screen and other movie and film related information. The home page screen provides a relatively simple page to page operation to understand operational and usage directions and an easy-to-use interface to accurately research and find movie and film excerpts. The mobile phone movie quote application may be readily available on mobile devices such as IPHONES™, BLACKBERRYS™ and other suitable smartphones with application compatibilities. The mobile phone movie quote application allows an individual to add friends and other contacts to their application as a way to effectively keep in touch with similar movie and film interests. The mobile phone movie quote application is downloadable and features several relatively easily navigable screens, allowing quick references to movies and other related information that friends can jointly participate in.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to access and utilize a mobile phone movie quote, comprising:
a server system;
a mobile phone;
a communications network where said server system is in communication with said mobile phone over said communications network downloads;
a mobile phone movie quote application that resides on said server system; and
a plurality of app updates that are provided to said mobile phone movie quote application to keep said system current.

2. The system according to claim 1, wherein said mobile phone includes a main display screen, a tags screen, a type search screen, a speak type search screen, a friends type screen and a voice receiving device.

3. The system according to claim 1, wherein said mobile phone is a client system.

4. The system according to claim 1, wherein said mobile phone is a smartphone is selected from the group consisting of an IPhone, a Blackberry or a Droid.

5. The system according to claim 1, wherein said communications network is selected from the group consisting of one or more local area networks, wide area networks, wireless networks, telephone networks and the Internet.

6. The system according to claim 1, wherein said mobile phone movie quote application includes a home page screen, a tag screen, a movie screen, an actors or actresses screen, a quote screen and a friends screen.

7. A system to access and utilize a mobile phone movie quote, comprising:
a server system;
a mobile phone that includes a main display screen, a tags screen, a type search screen, a speak type search screen, a friends type screen and a voice receiving device;
a communications network where said server system is in communication with said mobile phone over said communications network downloads;
a mobile phone movie quote application that resides on said server system; and
a plurality of app updates that are provided to said mobile phone movie quote application to keep said system current.

8. The system according to claim 7, wherein said mobile phone is a client system.

9. The system according to claim 7, wherein said mobile phone is a smartphone is selected from the group consisting of an IPhone, a Blackberry or a Droid.

10. The system according to claim 7, wherein said communications network is selected from the group consisting of one or more local area networks, wide area networks, wireless networks, telephone networks and the Internet.

11. The system according to claim 7, wherein said mobile phone movie quote application includes a home page screen, a tag screen, a movie screen, an actors or actresses screen, a quote screen and a friends screen.

12. The system according to claim 11, wherein said home screen page is said main display screen.

13. The system according to claim 11, wherein said home screen page is an initial screen that is displayed when said movie quote application is opened.

14. A system to access and utilize a mobile phone movie quote, comprising:
a server system;
a mobile phone that includes a main display screen, a tags screen, a type search screen, a speak type search screen, a friends type screen and a voice receiving device;
a communications network where said server system is in communication with said mobile phone over said communications network downloads;
a mobile phone movie quote application that resides on said server system includes a home page screen, a tag screen, a movie screen, an actors or actresses screen, a quote screen and a friends screen; and
a plurality of app updates that are provided to said mobile phone movie quote application to keep said system current.

15. The system according to claim 14, wherein said mobile phone is a client system.

16. The system according to claim 14, wherein said mobile phone is a smartphone is selected from the group consisting of an IPhone, a Blackberry or a Droid.

17. The system according to claim 14, wherein said communications network is selected from the group consisting of one or more local area networks, wide area networks, wireless networks, telephone networks and the Internet.

18. The system according to claim 14, wherein said home screen page is said main display screen.

19. The system according to claim 14, wherein said home screen page is an initial screen that is displayed when said movie quote application is opened.

20. The screen according to claim 14, wherein said movie quote application is in communication over the Internet or other said communications network and is integrated with one or more said user's friends social media accounts.
